(19) United States
(12) Patent Application Publication
(10) Pub. No.: US 2008/0308012 A1
(43) Pub. Date: Dec. 18, 2008

(54) Burnt Product

(75) Inventors: Takayoshi Okamura, Tokyo (JP); Masahiko Moriya, Chiba (JP); Satoshi Yamazaki, Hokkaido (JP); Kota Sasaki, Chiba (JP); Makoto Kobayakawa, Tokyo (JP); Kenichi Honma, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Taiheiyo Cement Corporation, Chuo-ku (JP)

(21) Appl. No.: 11/908,132

(22) PCT Filed: Mar. 8, 2006
(86) PCT No.: PCT/JP2006/304481

§ 371 Date: Sep. 10, 2007

(30) Foreign Application Priority Data
Mar. 16, 2005 (JP) 2005-74738

(51) Int. Cl. C04B 18/10; C04B 18/04; C04B 28/14

(52) U.S. Cl. 106/705; 106/638; 106/811; 106/772; 106/782; 106/788

(57) ABSTRACT

A burnt product is produced by burning a raw material containing chromium, in which the fine-grained portion is removed. Even in the burnt product produced from a raw material containing chromium, the chromium (VI) content is reduced.

### TECHNICAL FIELD

The present invention relates to a burnt product produced using a raw material containing chromium, wherein the chromium (VI) content has been decreased.

### BACKGROUND ART

In Japan, with the growth of the economy and urban population, the amount of industrial and non-industrial waste is rapidly increasing. Most of these types of waste has been conventionally disposed of with its volume reduced to about one tenth by incineration; however, in recent years, the remaining landfill capacity has been scarce, and thus, establishing a new way of waste disposal is a problem of urgency. To cope with this problem, industrial waste or non-industrial waste has been used as a raw material to produce a burnt product for use in, for example, a cement admixture, cement or aggregate (e.g. Patent Document 1).

However, industrial waste or non-industrial waste contains a trace of chromium, and a burnt product produced using the waste as a raw material inevitably contains chromium (VI). If such a burnt product is used as an aggregate, or if the ground product of the burnt product is used as a cement admixture or cement, chromium (VI) contained in the burnt product may cause water pollution, soil pollution or the like. Thus, there have been demands for decreasing the chromium (VI) content in such a product.

### [Patent Document 1]: JP-A-2004-2155

### DISCLOSURE OF THE INVENTION

### [Problems to be Solved by the Invention]

Accordingly, the object of the present invention is to provide a burnt product produced using a raw material containing chromium, wherein the chromium (VI) content has been decreased. [Means for Solving the Problems]

In the light of the above described circumstances, the present inventors made a closer examination of burnt products produced by burning a raw material containing chromium, and they have found that a burnt product wherein the chromium (VI) content has been decreased can be obtained by removing the fine-grained portion from the burnt product.

Specifically, the present invention provides a burnt product produced by burning a raw material containing chromium, characterized in that the fine-grained portion is removed from the burnt product.

The present invention also provides a low-hydraulic material having a hydraulic modulus (H.M.) of less than 1.5, which is produced by grinding the above described burnt product.

The present invention also provides a hydraulic composition that contains: a ground product of the above described burnt product having a hydraulic modulus (H.M.) of 1.5 to 2.3; and gypsum.

### ADVANTAGES OF THE INVENTION

The burnt product of the present invention contains a decreased amount of chromium (VI), even though it is produced using a raw material containing chromium. Thus, even if the burnt product is used for a hydraulic material or aggregate, the elution of chromium (VI) is suppressed, whereby the environment load is decreased.

The burnt product of the present invention can be produced using industrial waste or non-industrial waste as a raw material, and thus, it can contribute to encouraging effective utilization of wastes.

### BEST MODE FOR CARRYING OUT THE INVENTION

As raw materials for the burnt product of the present invention, commonly used raw materials for Portland cement clinker, for example, CaO materials such as limestone, quick lime and slaked lime; SiO₂ materials such as silica and clay; Al₂O₃ materials such as clay; and Fe₂O₃ materials such as iron slag and iron cake can be used.

Further, the burnt product of the present invention can be produced by burning one or more selected from the group consisting of industrial waste, non-industrial waste and construction waste soil as raw materials. Examples of industrial waste include: ready mixed concrete sludge; various kinds of sludge such as sewage sludge, water purifying sludge, construction sludge and iron manufacture sludge; construction waste; concrete waste; drilling waste soil; various kinds of ash; molding sand; rock wool, waste glass; and blast furnace secondary ash. Examples of non-industrial wastes include: dried sewage sludge powder, municipal waste ash and shells. Examples of construction waste soils include: soil, surplus soil and waste soil from building sites or construction sites.

Of these examples, some of each of clay, iron slag, industrial waste, non-industrial waste and construction waste soil contains a large amount of chromium.

A burnt product is produced by mixing and burning some of the above described raw materials so that the burnt product has a hydraulic modulus (H.M.) preferably between 0.05 and 2.3 and more preferably between 0.4 and 2.3.

Preferably, the burning temperature is set depending on the hydraulic modulus (H.M.) of the intended burnt product. When the hydraulic modulus (H.M.) of the intended burnt product is less than 1.5, the burning temperature is preferably between 1000 and 1350° C. and particularly preferably between 1150 and 1350° C. When the hydraulic modulus (H.M.) of the intended burnt product is between 1.5 and 2.3, the burning temperature is preferably between 1200 and 1550° C. and particularly preferably between 1350 and 1450° C.

Methods of mixing raw materials are, but not specifically limited to, performed on common apparatuses.

Apparatuses used for burning are not specifically limited to, either. Burning can be performed using, for example, a rotary kiln. When carrying out burning on a rotary kiln, waste as a substitute fuel, such as waste oil, scrap tire or waste plastics, can also be used.

A burnt product produced by burning raw materials containing chromium inevitably contains chromium (VI). The present inventors have found that the chromium (VI) content in such a burnt product tends to increase with decreasing grain diameter of the burnt product. Thus, in the present invention, a burnt product having low chromium (VI) content is obtained by removing the fine-grained portion from the burnt product.

The fine-grained portion to be removed is preferably composed of grains with a diameter of 2 mm or smaller and particularly preferably grains with a diameter of 5 mm or smaller.

Methods of removing the fine-grained portion from the burnt product include: for example, subjecting the burnt product to sieving. When using, as an apparatus for producing a burnt product, an existing cement production plant, the fine-grained portion can be removed by drawing out the spillage dust from the cooling-air type clinker cooler of the plant or drawing out the dust collected through the dust collector of the clinker cooler of the plant.

The removed fine-grained portion of the burnt product can be used as a raw material for a burnt product in the as-removed condition. Alternatively the removed fine-grained portion of the burnt product can undergo water-wash treatment or undergo heat treatment in a reducing atmosphere or an inert atmosphere before being used as a raw material or being used in the form of a mixture with the other portion of the burnt product, as described later. Subjecting the removed fine-grained portion to water-wash treatment or heat treatment in a reducing atmosphere or an inert atmosphere makes it possible to decrease the chromium (VI) content in the burnt product.

The present inventors have found that in a burnt product produced by burning a raw material containing chromium, the amount of chromium (VI) eluted from the burnt product tends to increase with decreasing grain diameter of the burnt product. Thus, in the present invention, the chromium (VI) content in a burnt product is drastically decreased by water-washing and drying the fine-grained portion removed from the burnt product. The fine-grained portion of the burnt product having been water-washed and dried can be used in the form of a mixture with the other portion of the burnt product, and besides, it can be used independently as a raw material for a burnt product.

In water-washing the fine-grained portion of the burnt product, when the hydraulic modulus (H.M.) of the burnt product is 1.5 or higher, chromium (VI) is taken in the hydrate of the burnt product, whereby chromium (VI) becomes hard to be removed. Accordingly, it is preferable to wash the fine-grained portion in an aqueous solution that contains a component capable of suppressing the hydration of the burnt product. Examples of such a component include: retarding agents such as sulfate, saccharides, citric acid and heptonic acid.

When the hydraulic modulus (H.M.) of the burnt product is less than 1.5, the hydrating activity of the burnt product is low, whereby chromium (VI) can be removed by washing with ordinary water.

Methods of water-washing the burnt product include: for example, (1) a method in which the burnt product is stored in storage facilities and water is sprinkled over the product from the top portion of the facilities using a sprinkler or the like and drained from the bottom portion of the facilities; and (2) a method in which the burnt product is fed to a belt conveyer while water is sprinkled over the product through a spray nozzle located above the belt conveyer and drained from the bottom portion of the conveyer.

After dried, the water-washed fine-grained portion can be used in the form of a mixture with the other portion of the burnt product or can be used alone as a raw material for a burnt material.

The washing water having been used for the water-washing and containing chromium (VI) can be disposed of after treated with a reducing agent (e.g. ferrous sulfate etc.).

Further, the present inventors have found that in the burnt product produced by burning raw materials containing chromium, chromium (III) tends to be oxidized to chromium (VI) during burning, since its surface area/volume increases with decreasing grain diameter of the burnt product. Thus, in the present invention, the removed fine-grained portion of the burnt product is heat treated in a reducing atmosphere or an inert atmosphere so as to decrease the amount of chromium (VI) in the burnt product drastically. The fine-grained portion after heat treatment can be used in the form of a mixture with the other portion of the burnt product, and besides, it can be used independently as a raw material for a burnt product.

Methods of making the inside of a heating furnace in a reducing atmosphere include: for example, a method in which combustibles (e.g. activated carbon, waste woods and waste plastics) are fed into the heating furnace; and a method in which the atmosphere in the heating furnace is replaced with CO gas or the like. Methods of making the inside of a heating furnace in an inert atmosphere include: for example, a method in which the atmosphere in the heating furnace is replaced with nitrogen gas or the like.

Preferably, the temperature at which the heat treatment is performed is 800 to 1100° C. and the temperature for which the heat treatment is performed is 5 to 60 minutes.

The burnt product of the present invention thus obtained can be used as it is, or without requiring grinding, as a raw material for a mortar or concrete aggregate, base course material, back filling material, asphalt aggregate, banking material, filler, or cement clinker.

The burnt product of the present invention can also be used as a hydraulic material or the like after being ground.

When using the burnt product of the present invention in the ground form, the product having a hydraulic modulus (H.M.) of less than 1.5 can be made into:

(1) a low-hydraulic material obtained by grinding the burnt product with a hydraulic modulus (H.M.) of less than 1.5; and
(2) a low-hydraulic material which contains not more than 6 parts by mass of gypsum, in terms of SO₃, with respect to 100 parts of the ground product.

Methods of grinding the burnt product are not limited to any specific ones. The burnt product can be ground by the usual method using, for example, a ball mill or the like. From the viewpoint of the decrease in bleeding of mortar or concrete or the flowability or strength development of the same, preferably the ground product of the burnt product has a Blaine specific surface area of 2500 to 5000 cm²/g.

Kinds of gypsum include: dihydrate gypsum, hemihydrate gypsum and anhydrous gypsum. Either one kind of gypsum alone or two or more kinds of gypsum in combination can be used.

A low-hydraulic material which is obtained by mixing the ground product of the burnt product with gypsum may be produced by mixing the ground product of the burnt product with gypsum or by grinding the burnt product and gypsum simultaneously. In the former case, it is preferable, from the viewpoint of the flowability or strength development of mortar or concrete, to use gypsum having a Blaine specific surface area of 3000 to 8000 cm²/g. In the latter case, it is preferable, from the viewpoint of the decrease in bleeding of mortar or concrete or the flowability or strength development thereof, that the low-hydraulic material has a Blaine specific surface area of 2500 to 5000 cm²/g.

The burnt product having a hydraulic modulus (H.M.) of 1.5 to 2.3 can be made into:

(1) a hydraulic composition that contains not more than 6 parts by mass of gypsum, in terms of SO₃, with respect to 100 parts of the ground product of the burnt product with a hydraulic modulus (H.M.) of 1.5 to 2.3;
(2) a hydraulic composition that contains: the ground product of the burnt product with a hydraulic modulus (H.M.) of 1.5 to 2.3, the ground product of the burnt product with a hydraulic modulus (H.M.) of less than 1.5, and gypsum;
(3) a hydraulic composition that contains: the ground product of Portland cement clinker, the ground product of the burnt product with a hydraulic modulus (H.M.) of less than 1.5, and gypsum; and
(4) a hydraulic composition that contains: at least one of the hydraulic compositions (1) to (3), and one kind or more of inorganic powders selected from the group consisting of blast furnace slag powder, fly ash, limestone powder and silica powder.

Methods of grinding the burnt product or Portland cement clinker are not limited to any specific ones. They can be ground by the usual method using, for example, a ball mill or the like.

Kinds of gypsum include: dihydrate gypsum, hemihydrate gypsum and anhydrous gypsum. Either one kind of gypsum alone or two or more kinds of gypsum in combination can be used.

The above described hydraulic composition (1) may be produced by mixing the ground product of the burnt product with gypsum or by grinding the burnt product and gypsum simultaneously. In the former case, it is preferable, from the viewpoint of the decrease in bleeding of mortar or concrete or the flowability or strength development thereof, that the ground product of the burnt product has a Blaine specific surface area of 2500 to 4500 cm²/g and the gypsum has a Blaine specific surface area of 3000 to 8000 cm²/g. In the latter case, it is preferable, from the viewpoint of the decrease in bleeding of mortar or concrete or the flowability or strength development thereof, that the hydraulic composition has a Blaine specific surface area of 3000 to 4500 cm²/g.

The above described hydraulic composition (2) may be produced by: for example,

(a) a method in which the burnt product with a hydraulic modulus (H.M.) of 1.5 to 2.3 (hereinafter referred to burnt product A), the burnt product with a hydraulic modulus (H.M.) of less than 1.5 (hereinafter referred to burnt product B), and gypsum are ground simultaneously;
(b) a method in which the burnt product A and the burnt product B are ground simultaneously, and the resultant ground product is mixed with gypsum;
(c) a method in which the burnt product A and gypsum are ground simultaneously, and the resultant ground product is mixed with the ground product of the burnt product B;
(d) a method in which the burnt product B and gypsum are ground simultaneously, and the resultant ground product is mixed with the ground product of the burnt product A;
(e) a method in which the burnt product A and the burnt product B are ground separately, and both the ground products are mixed with gypsum; or
(f) a method in which the combination of burnt product A and gypsum and that of the burnt product B and gypsum are ground simultaneously, respectively, and both the ground products are mixed with each other.

In the case of the above described (a), it is preferable, from the viewpoint of the hydration heat of the hydraulic composition and the bleeding, flowability or strength development of mortar or concrete, that the burnt product A, the burnt product B and gypsum are ground so that they have a Blaine specific surface area of 3000 to 4500 cm²/g.

In the case of the above described (b), it is preferable, from the viewpoint of the hydration heat of the hydraulic composition and the bleeding, flowability or strength development of mortar or concrete, that the burnt product A and the burnt product B are ground so that they have a Blaine specific surface area of 2500 to 4500 cm²/g. And it is preferable to use gypsum having a Blaine specific surface area of 3000 to 8000 cm²/g.

In the case of the above described (c), it is preferable, from the viewpoint of the hydration heat of the hydraulic composition and the bleeding, flowability or strength development of mortar or concrete, that the burnt product A and gypsum are ground so that they have a Blaine specific surface area of 2500 to 4500 cm²/g. And it is preferable, from the viewpoint of the hydration heat of the hydraulic composition and the bleeding, flowability or strength development of mortar or concrete, that the burnt product B is ground so that it has a Blaine specific surface area of 2500 to 4500 cm²/g.

In the case of the above described (d), it is preferable, from the viewpoint of the hydration heat of the hydraulic composition and the bleeding, flowability or strength development of mortar or concrete, that the burnt product B and gypsum are ground so that they have a Blaine specific surface area of 2500 to 4500 cm²/g. And it is preferable, from the viewpoint of the hydration heat of the hydraulic composition and the bleeding, flowability or strength development of mortar or concrete, that the burnt product A is ground so that it has a Blaine specific surface area of 2500 to 4500 cm²/g.

In the case of the above described (e), it is preferable, from the viewpoint of the hydration heat of the hydraulic composition and the bleeding, flowability or strength development of mortar or concrete, that the burnt product A and the burnt product B are separately ground so that they have a Blaine specific surface area of 2500 to 4500 cm²/g. And it is preferable to use gypsum having a Blaine specific surface area of 3000 to 8000 cm²/g.

In the case of the above described (f), it is preferable, from the viewpoint of the bleeding, flowability or strength development of mortar or concrete, that the combination of the burnt product A and gypsum and that of the burnt product B and gypsum are ground so that they have a Blaine specific surface area of 2500 to 4500 cm²/g.

From the viewpoint of the flowability or strength development of mortar or concrete, preferably the hydraulic composition (2) has a Blaine specific surface area of 3000 to 4500 cm²/g.

From the viewpoint of the hydration heat of the hydraulic composition and the flowability, setting or strength development of mortar or concrete, in the above described hydraulic composition (2), the content of the ground product of the burnt product B is preferably 1 to 100 parts by mass and particularly preferably 2 to 50 parts by mass with respect to 100 parts of the ground product of the burnt product A. From the viewpoint of the flowability or strength development of mortar or concrete, the content of gypsum is preferably 1 to 6 parts by mass and particularly preferably 2 to 4 parts by mass, in terms of SO₃, with respect to 100 parts of the ground product of the burnt product A.

The above described hydraulic composition (3) may be produced by: for example,

(a) a method in which Portland cement clinker, the burnt product B, and gypsum are ground simultaneously;
(b) a method in which Portland cement clinker and the burnt product B are ground simultaneously, and the resultant ground product is mixed with gypsum;
(c) a method in which Portland cement clinker and gypsum are ground simultaneously, and the resultant ground product is mixed with the ground product of the burnt product B;
(d) a method in which the burnt product B and gypsum are ground simultaneously, and the resultant ground product is mixed with the ground product of Portland cement clinker; or
(e) a method in which Portland cement clinker and the burnt product B are ground separately, and both the ground products are mixed with gypsum.

In the case of the above described (a), it is preferable, from the viewpoint of the hydration heat of the hydraulic composition and the bleeding, flowability or strength development of mortar or concrete, that Portland cement clinker, the burnt product B and gypsum are ground so that they have a Blaine specific surface area of 3000 to4500 cm²/g.

In the case of the above described (b), it is preferable, from the viewpoint of the hydration heat of the hydraulic composition and the bleeding, flowability or strength development of mortar or concrete, that Portland cement clinker and the burnt product B are ground so that they have a Blaine specific surface area of 2500 to 4500 cm²/g. And it is preferable to use gypsum having a Blaine specific surface area of 3000 to 8000 cm²/g.

In the case of the above described (c), it is preferable, from the viewpoint of the hydration heat of the hydraulic composition and the bleeding, flowability or strength development of mortar or concrete, that Portland cement clinker and gypsum are ground so that they have a Blaine specific surface area of 2500 to 4500 cm²/g. And it is preferable, from the viewpoint of the hydration heat of the hydraulic composition and the bleeding, flowability or strength development of mortar or concrete, that the burnt product B is ground so that it has a Blaine specific surface area of 2500 to 4500 cm²/g.

In the case of the above described (d), it is preferable, from the viewpoint of the hydration heat of the hydraulic composition and the bleeding, flowability or strength development of mortar or concrete, that the burnt product B and gypsum are ground so that they have a Blaine specific surface area of 2500 to 4500 cm²/g. And it is preferable, from the viewpoint of the hydration heat of the hydraulic composition and the bleeding, flowability or strength development of mortar or concrete, that Portland cement clinker is ground so that it has a Blaine specific surface area of 2500 to 4500 cm²/g.

In the case of the above described (e), it is preferable, from the viewpoint of the hydration heat of the hydraulic composition and the bleeding, flowability or strength development of mortar or concrete, that Portland cement clinker and the burnt product B are separately ground so that they have a Blaine specific surface area of 2500 to 4500 cm²/g. And it is preferable to use gypsum having a Blaine specific surface area of 3000 to 8000 cm²/g.

From the viewpoint of the flowability or strength development of mortar or concrete, preferably the hydraulic composition (3) has a Blaine specific surface area of 3000 to 4500 cm²/g.

From the viewpoint of the hydration heat of the hydraulic composition and the flowability, setting or strength development of mortar or concrete, in the above described hydraulic composition (3), the content of the ground product of the burnt product B is preferably 1 to 100 parts by mass and particularly preferably 2 to 50 parts by mass with respect to 100 parts of the ground product of Portland cement clinker. From the viewpoint of the flowability or strength development of mortar or concrete, the content of gypsum is preferably 1 to 6 parts by mass and particularly preferably 2 to 4 parts by mass, in terms of SO₃, with respect to 100 parts of the ground product of Portland cement clinker.

The above described hydraulic composition (4) is obtained by mixing any one of the above described hydraulic compositions (1) to (3) with one or more kinds of inorganic powders selected from the group consisting of blast furnace slag powder, fly ash, limestone powder and silica powder.

The content of inorganic powder varies depending on the kind of the inorganic powder. When the inorganic powder is blast furnace slag powder, from the viewpoint of the flowability or strength development of mortar or concrete, the effect of suppressing alkali aggregate reaction and the sulfate resistance, the content is preferably 5 to 200 parts by mass and particularly preferably 10 to 150 parts by mass with respect to 100 parts of any one of the above described hydraulic compositions (1) to (3). When the inorganic powder is fly ash, limestone powder or silica powder, the content is preferably 5 to 150 parts by mass and particularly preferably 10 to 100 parts by mass with respect to 100 parts of any one of the above described hydraulic compositions (1) to (3). When blast furnace slag powder and limestone powder are used in combination as the inorganic powder, from the viewpoint of the flowability or strength development of mortar or concrete, the content of blast furnace slag powder is preferably 5 to 200 parts by mass with respect to 100 parts of any one of the above described hydraulic compositions (1) to (3) and the content of limestone powder is preferably 1 to 30 parts by mass with respect to 100 parts of any one of the above described hydraulic compositions (1) to (3).

The above described hydraulic composition (4) can be produced by mixing any one of the above described hydraulic compositions (1) to (3) with one or more kinds of inorganic powders.

From the viewpoint of the flowability or strength development of mortar or concrete, it is preferable to use inorganic powders having a Blaine specific surface area of 2500 to 6000 cm²/g, more preferably 3000 to 5000 cm²/g.

From the viewpoint of the flowability or strength development of mortar or concrete, preferably the hydraulic composition (4) has a Blaine specific surface area of 2500 to 4500 cm²/g and particularly preferably 3000 to 4500 cm²/g.

### EXAMPLES

In the following the present invention will be described in further detail by examples; however, it is to be understood that these examples are not intended to limit the present invention.

### Example 1

### (1) Production of Burnt Product

Coal ash, sewage sludge, construction waste soil, and raw materials for Portland cement clinker such as limestone, as raw materials, were prepared, so that their hydraulic moduli (H.M.) were 1.35, 0.9 and 0.55, respectively. Each of the prepared materials was burnt in a small rotary kiln at 1200 to 1350° C. to obtain a burnt product. In this burning, not only heavy oil, which is commonly used as fuel oil, but also waste oil or waste plastics were used.

(2) Measurement of Amount of Chromium (VI) Eluted from Each Burnt Product, According to Grain Size

Each of the above described burnt products was sieved out into: grains with a diameter of larger than 15 mm (>15); grains with a diameter of larger than 10 mm and equal to or smaller than 15 mm (10-15); grains with a diameter of larger than 5 mm and equal to or smaller than 10 mm (5-10); grains with a diameter of larger than 2 mm and equal to or smaller than 5 mm (2-5); grains with a diameter of larger than 0.5 mm and equal to or smaller than 2 mm (0.5-2); and grains with a diameter of smaller than 0.5 mm (0.5>).

The amount of chromium (VI) eluded from each of the burnt products with the respective grain diameters and that of chromium (VI) eluted from the burnt materials not having been sieved were measured in accordance with 46^{th} announcement by the Environment Agency. The results are shown in Table 1.

TABLE 1

| | Amount of chromium (VI) eluted (mg/L) | | |
|---|---|---|---|
| | | Burnt product | |
| Grain | Burnt product | having a | Burnt product |
| diameter | having a hydraulic | hydraulic | having a hydraulic |
| (mm) | modulus of 1.35 | modulus of 0.9 | modulus of 0.55 |
| >15 | 0.69 | 0.08 | <0.02 |
| 10-15 | 0.86 | 0.32 | 0.04 |
| 5-10 | 1.30 | 0.45 | 0.07 |
| 2-5 | 1.60 | 0.62 | 0.09 |
| 0.5-2 | 1.80 | 1.00 | 0.13 |
| 0.5> | 2.30 | 1.20 | 0.16 |
| 5.0 or | 0.75 | 0.25 | 0.04 |
| larger | | | |
| 2.0 or | 0.88 | 0.33 | 0.06 |
| larger | | | |
| Smaller | 1.90 | 1.20 | 0.14 |
| than 2.0 | | | |
| Not having | 1.20 | 0.64 | 0.10 |
| been | | | |
| sieved | | | |

The results shown in Table 1 indicate that the amount of chromium (VI) eluted increases with decreasing grain diameter of burnt material. They also indicate that the amount of chromium (VI) eluted is small in the burnt product prepared by removing the fine-grained portion (less than 2.0 mm in diameter, less than 0.5 mm in diameter) from the burnt product, compared with that of the burnt product.

### Example 2

The burnt products with a hydraulic modulus of 1.35 and 0.9, respectively, which were prepared in Example 1, were sieved into: grains with a diameter of 2.0 mm or larger; and grains with a diameter of smaller than2.0 mm. Of the materials, those with a grain diameter of smaller than 2.0 mm underwent reductive heating in an electric furnace at 1000° C. in the presence of activated carbon for 10 minutes and were mixed with those with a grain diameter of 2.0 mm or larger, and the amount of chromium (VI) eluted from each product was measured in accordance with 46^{th} announcement by the Environment Agency.

The measured amounts of chromium (VI) eluted were 0.85 mg/L for the burnt product with a hydraulic modulus of 1.35 and 0.32 mg/L for the burnt product with a hydraulic modulus of 0.9.

### Example 3

The burnt products with a hydraulic modulus of 0.9 and 1.35, respectively, which were prepared in Example 1, were sieved into: grains with a diameter of 2.0 mm or larger; and grains with a diameter of smaller than 2.0 mm. Of the materials, those with a grain diameter of smaller than 2.0 mm underwent heating in an electric furnace at 1000° C. in the presence of nitrogen gas for 20 minutes and were mixed with those with a grain diameter of 2.0 mm or larger, and the amount of chromium (VI) eluted from each product was measured in accordance with 46^{th} announcement by the Environment Agency.

The measured amounts of chromium (VI) eluted were 0.35 mg/L for the burnt product with a hydraulic modulus of 0.9 and 0.88 mg/L for the burnt product with a hydraulic modulus of 1.35.

### Example 4

The burnt products with a hydraulic modulus of 1.35 and 0.9, respectively, which were prepared in Example 1, were sieved into: grains with a diameter of 2.0 mm or larger; and grains with a diameter of smaller than 2.0 mm. Of the materials, those with a grain diameter of smaller than 2.0 mm were fed on a belt conveyer, washed with water sprayed through a nozzle located above the belt conveyer, dried, and mixed with those with a grain diameter of 2.0 mm or larger, and the amount of chromium (VI) eluted from each product was measured in accordance with 46^{th} announcement by the Environment Agency.

The measured amounts of chromium (VI) eluted were 0.82 mg/L for the burnt product with a hydraulic modulus of 1.35 and 0.30 mg/L for the burnt product with a hydraulic modulus of 0.9.

### Example 5

### (1) Production of Burnt Product

Sewage sludge, construction waste soil, and materials for Portland cement clinker such as limestone, as raw materials, were prepared, so that their hydraulic moduli (H.M.) were 2.1 and 1.8, respectively. Each of the prepared materials was burnt in a small rotary kiln at 1400 to 1450° C. to produce a burnt product.

### (2) Preparation of Hydraulic Composition

(1) The burnt product obtained in (1) was classified into: (1) grains with a diameter of 5 mm or larger; (2) grains with a diameter of 2 mm or larger; and (3) grains not having been sieved.

To each of the classified products, 2 parts by mass of dihydrate gypsum, in terms of SO₃, was added, and the mixture was ground so that its Blaine specific surface area was 3200 cm²/g.

(3) Measurement of Amount of Chromium (VI) Eluted from Each Hydraulic Composition

The amount of chromium (VI) eluded from each of the above described hydraulic compositions was measured in accordance with 46^{th} announcement by the Environment Agency. The results are shown in Table 2.

TABLE 21

| | |
|---|---|
| Particle | Amount of chromium (VI) |
| diameter of | eluted (mg/L) |

| burnt material | Hydraulic | Hydraulic |
|---|---|---|
| (mm) | modulus 2.1 | modulus 1.8 |
| 5.0 or larger | 0.36 | 0.38 |
| 2.0 or larger | 0.48 | 0.49 |
| Not having been | 0.71 | 0.77 |
| sieved | | |

The results shown in Table 2 indicate that the amount of chromium (VI) eluted is small in hydraulic compositions which use a burnt product obtained by removing the fine-grained portion from the burnt product.

1. A burnt product produced by burning a raw material comprising chromium, a fine-grained portion of the burnt product being removed.

2. A burnt product produced by mixing the burnt product according to claim 1 with the removed fine-grained portion which has undergone water-washing and drying.

3. A burnt product produced by mixing the burnt product according to claim 1 with the removed fine-grained portion which has undergone heat-treating in a reducing atmosphere or an inert atmosphere.

4. The burnt product according to claim 1, produced with the removed fine-grained portion as a raw material comprising chromium.

5. The burnt product according to claim 1, produced with the removed fine-grained portion having undergone water-washing as a raw material comprising chromium.

6. The burnt product according to claim 1, produced with the removed fine-grained portion having undergone heat-treating in a reducing atmosphere or an inert atmosphere as a raw material comprising chromium.

7. The burnt product according to claim 1, having a hydraulic modulus of 0.05 to 2.3.

8. The burnt product according to claim 1, comprising one or more kinds selected from the group consisting of industrial waste, non-industrial waste and construction waste soil as raw materials.

9. A low-hydraulic material having a hydraulic modulus of less than 1.5, produced by grinding the burnt product according to claim 1.

10. A low-hydraulic material having a hydraulic modulus of less than 1.5, comprising not more than 6 parts by mass of gypsum, in terms of SO₃, with respect to 100 parts of the burnt product according to claim 1.

11. A hydraulic composition having a hydraulic modulus of 1.5 to 2.3, comprising not more than 6 parts by mass of gypsum, in terms of SO₃, with respect to 100 parts of the burnt product according to claim 1.

12. A hydraulic composition, comprising: a ground product of the burnt product according to claim 1 having a hydraulic modulus of 1.5 to 2.3; a ground product of the burnt product according to claim 1 having a hydraulic modulus of less than 1.5; and gypsum.

13. A hydraulic composition, comprising: a ground product of Portland cement clinker; a ground product of the burnt product according to claim 1 having a hydraulic modulus of less than 1.5; and gypsum.

14. The hydraulic composition according to claim 11, further comprising one or more kinds of inorganic powder selected from the group consisting of powdered blast furnace slag, fly ash, powdered limestone and powdered silica.

15. The hydraulic composition according to claim 12, further comprising one or more kinds of inorganic powder selected from the group consisting of powdered blast furnace slag, fly ash, powdered limestone and powdered silica.

16. The hydraulic composition according to claim 13, further comprising one or more kinds of inorganic powder selected from the group consisting of powdered blast furnace slag, fly ash, powdered limestone and powdered silica.
